(19) United States
(12) Patent Application Publication
(10) Pub. No.: US 2007/0077937 A1
(43) Pub. Date: Apr. 5, 2007

(54) Method and system for performing call admission control in a communication system

(76) Inventors: Kajamalai G. Ramakrishnan, Nashua, NH (US); Sundar Rangamani, Windham, NH (US)

Correspondence Address: MOTOROLA, INC., 1303 EAST ALGONQUIN ROAD, IL01/3RD, SCHAUMBURG, IL, 60196, US

(21) Appl. No.: 11/213,299

(22) Filed: Aug. 26, 2005

(51) Int. Cl. H04Q 7/20

(52) U.S. Cl. 455/453; 379/114.08; 379/133; 455/452.2

(57) ABSTRACT

A method and system for performing call admission control (CAC) in a communication system. The method comprises determining whether traffic of at least one call-type is overloaded in a predetermined measuring window. The method further comprises reallocated the resources of each call-type in response to determining whether traffic of at least call-type is overloaded in the predetermined measuring window.

### FIELD OF THE INVENTION

The invention relates generally to a communication system. More specifically, the invention relates to a method and system for performing call admission control (CAC) in a communication system.

### BACKGROUND OF THE INVENTION

In existing communication systems, all incoming calls of different priorities are treated and controlled alike. Controlling of multiple call-types of traffic alike without any differentiation is known as an undifferentiated CAC. In the undifferentiated CAC when calls of different priorities arrive in real time, a sudden burst of calls of a lower priority can result in dropping of calls of higher priority. As a result, there is degradation of throughput and Quality of Service (QoS) during peak traffic patterns.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a flow diagram of a method for managing a plurality of calls in a communication system in accordance with an embodiment of the invention.

FIG. 2 is a flow diagram of a method for performing call admission control (CAC) in a communication system in accordance with an embodiment of the invention.

FIG. 3 is a flow diagram of a method for reallocating resources to each call-type in accordance with an embodiment of the invention.

FIG. 4 is a flow diagram of a method for managing a plurality of calls in a communication system in accordance with another embodiment of the invention.

FIG. 5 is a block diagram of a call manager in accordance with an embodiment of the invention.

FIG. 6 is a block diagram of a call admission controller in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to managing a plurality of calls in a communication system. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a call manager described herein. The non-processor circuits may include, but are not limited to, a radio receiver, a radio transmitter, signal drivers, clock circuits, power source circuits, and user input devices. As such, these functions may be interpreted as steps of a method to manage a plurality of calls in a communication system. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

A method and system is provided for performing call admission control (CAC) in a communication system. The method comprises determining whether traffic of at least one call-type is overloaded in a predetermined measuring window. The method further comprises reallocating the resources of each call-type in response to determining whether traffic of at least one call-type is overloaded in the predetermined measuring window.

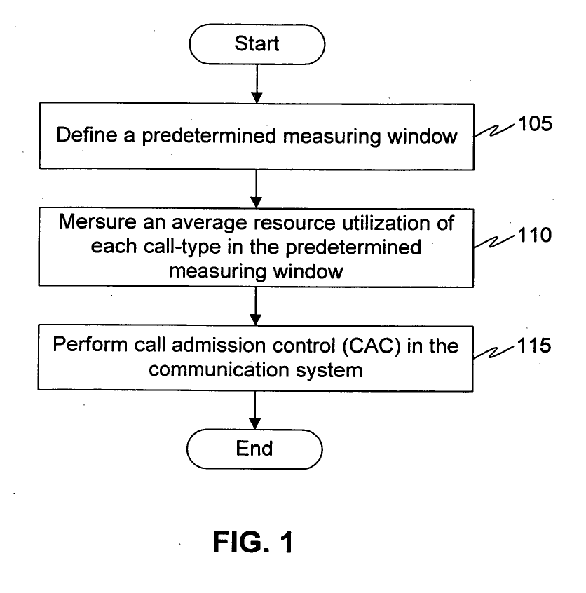

FIG. 1 is a flow diagram of a method for managing a plurality of calls in a communication system in accordance with an embodiment of the invention. The communication system comprises at least one call-type and a call belongs to a particular call-type. In an embodiment of the invention, a call-type may be a multimedia call-type. In another embodiment of the invention, a call-type may be a voice call-type. In yet another embodiment of the invention, a call-type may be a data call-type, for example, a short message service (SMS) call-type.

At step 105, a predetermined measuring window is defined. In an exemplary embodiment of the invention, the predetermined measuring window is a defined time period. The size of the window may depend on many factors, for example, the ambient arrival rates of calls, the average holding time of a call, and the system's requirement for rapid reactions to bursts of calls. There is a trade-off between setting the window size too small and too large; too small a window size will cause the system to react myopically to short term bursts, resulting in poor throughput; on the other hand, too large a window size will make the system not react to persistent bursts resulting in dangerous overload. Historical traffic engineering suggests a good compromise—set the window size roughly equal to twice the average holding time of calls. From experiments performed so far, this compromise works well in practice. However, the size of the window is up to the designer of the communication system and one of ordinary skill in the art realizes that many window sizes may be used here.

At step 101, an average resource utilization of each call-type is measured in the predetermined measuring window. In an exemplary embodiment of the invention, the average resource utilization of a call-type is measured by estimating resource utilization of the call-type in the predetermined measuring window based on an aggregate central processing unit (CPU) resource utilization in the predetermined measuring window. In an embodiment of the invention, the estimation of CPU utilization comprises an off-line procedure and an on-line procedure.

In the off-line procedure, the CPU time for processing one call of each call-type is measured. The procedure is repeated to take into account the variations of CPU time under various load conditions. In an embodiment of the invention, CPU time for processing the call-type is estimated using the central limit theorem. The central limit theorem states that a mean of N independent, identically distributed random variables with mean μ and variance σ² is normally distributed with a mean μ and variance

$$\frac{{σ}^{2}}{N} .$$

Therefore, if X is the random variable, which is the mean of N observations, then X has a normal distribution with mean μ and variance

$$\frac{{σ}^{2}}{N} .$$

It follows that the dependent random variable Y is defined as

$$Y = \frac{( X - μ )}{σ \text{/} \sqrt{N}} \qquad ( 1 )$$

Y is a standard Gaussian distribution. From the numerical integration tables it is known with a 99% confidence that the mass is contained within 2.7:

$${\int }_{- 2.7}^{2.7} {ⅇ}^{- {Y}^{2} \text{/} 2} ⅆ Y = 0.99 \qquad ( 2 )$$

Hence, using the central limit theorem it may be estimated with a 99% confidence that CPU time for processing the call-type is no more than:

$${S}_{i} = {μ}_{i} + \frac{2.7 {σ}_{i}}{\sqrt{N}} \qquad ( 3 )$$

where,
Sᵢ denotes the estimated CPU time for processing a call of the call-type i;

$$\begin{matrix}{μ}_{i} = \begin{matrix}( 1 \text{/} N ) \sum {S}_{i}^{k} ; & 1 \leq k \leq N\end{matrix} \\ {σ}_{i}^{2} = \frac{1}{N - 1} \sum {( {S}_{i}^{k} - {μ}_{i} )}^{2}\end{matrix}$$
N is the number of times the procedure is repeated for the call-type i; and
Sᵢ^{k} is the measured CPU time per call corresponding to the experiment k.

In an on-line procedure, a number of calls corresponding to each call-type is tracked in the predetermined measuring window. In an embodiment of the invention, the estimated resource utilization of the call-type i is given by:

$${u}_{i} = \frac{{n}_{i} {S}_{i}}{\sum {n}_{i} {S}_{i}} u \qquad ( 4 )$$

where,
u is the aggregate CPU resource utilization during the predetermined measuring window; and
nᵢ is the number of calls corresponding to the call-type i.

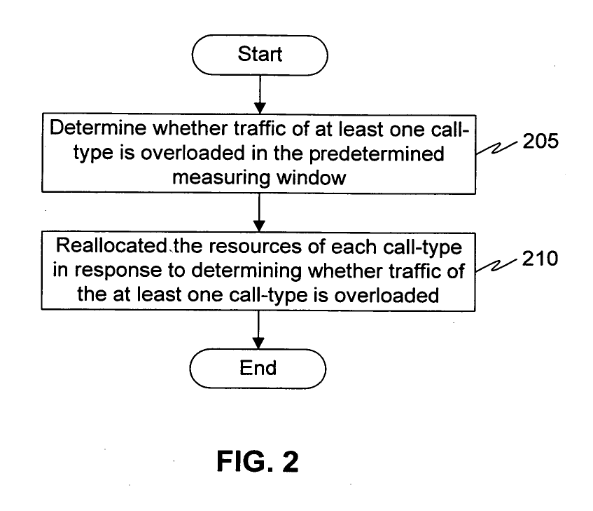

At step 115, a CAC is performed in the communication system. This is further explained in conjunction with FIG. 2.

FIG. 2 is a flow diagram of a method for performing CAC in a communication system in accordance with an embodiment of the invention. In an embodiment of the invention, the CAC is performed at the end of the predetermined measuring window.

At step 205, it is determined whether traffic of at least one call-type is overloaded in the predetermined measuring window. In an embodiment of the invention, traffic of a call-type is overloaded if the average resource utilization corresponding to the call-type is greater than a resource-utilization-upper bound of the call-type. In another embodiment of the invention, traffic of a call-type is overloaded if the average resource utilization corresponding to the call-type is greater than a predetermined threshold.

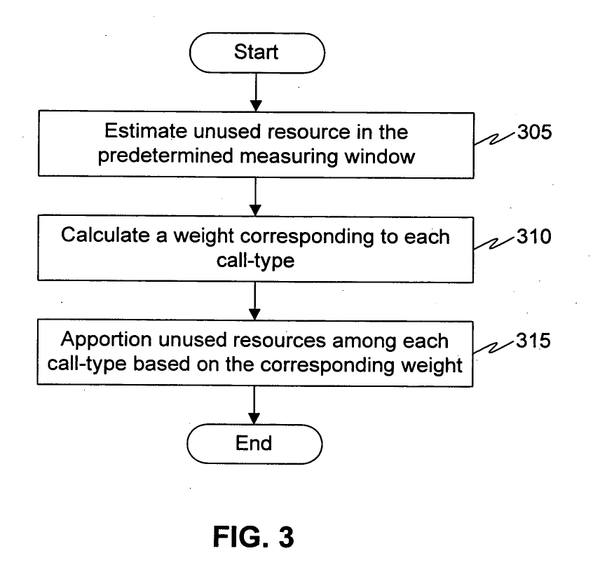

At step 210, resources are reallocated to each call-type in response to determining whether the traffic of the at least one call-type is overloaded. This is further explained in conjunction with FIG. 3.

FIG. 3 is a flow diagram of a method for reallocating resources to each call-type in accordance with an embodiment of the invention. At step 305, unused resources in the predetermined measuring window are estimated in the communication system. In an embodiment of the invention, the unused resources are the aggregate of excess resources that may not be used in the predetermined measuring window. The unused resources are given by:
Δ=Σ(Ubᵢ−Uᵢ) for Uᵢ≦Ubᵢ; 1≦i≦M (5)
where,
Δ is unused resource available in the communication system in the predetermined measuring window;
M is total number of the call-type in the communication system;
Uᵢ is the average resource utilization corresponding to the call-type i in the predetermined measuring window; and
Ubᵢ is the resource-utilization-upper bound corresponding to the call-type i.

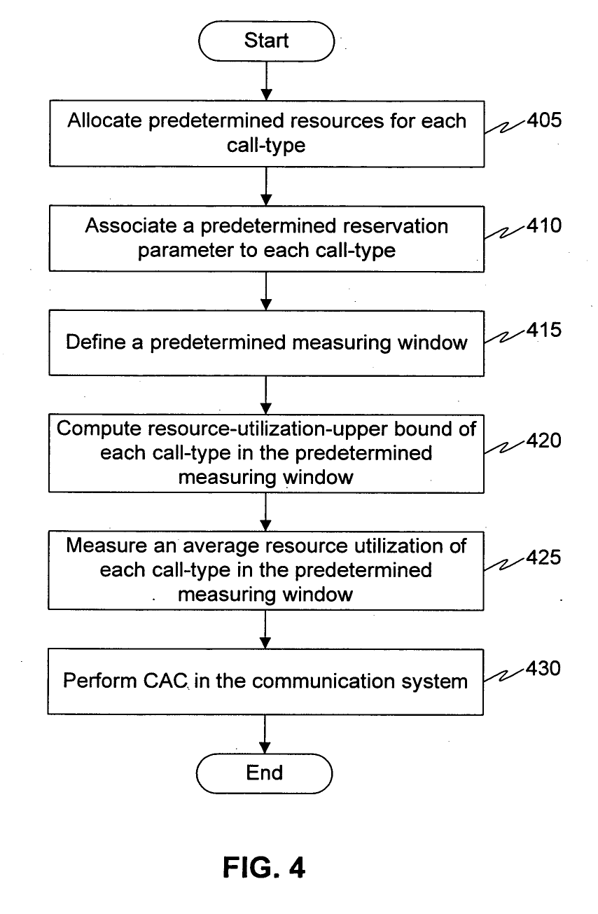

The unused resources in the predetermined measuring window are allotted to call-types that are overloaded in the predetermined measuring window. In an embodiment of the invention, the unused resources are allotted to call-types depending on a set of criterions. At step 310, a weight is calculated corresponding to the at least one call-type. In an embodiment of the invention, a weight of a call-type is a function of a priority assigned to the call-type and the average resource utilization of the call-type. In an exemplary embodiment of the invention, the weight (wᵢ) corresponding to a call-type i is defined as:
wᵢ=e^{(Ub}^{ᵢ}^{-U}^{ᵢ}⁾max(Δ−rᵢ,0) (6)
where,
rᵢ is a reservation parameter assigned to the call-type i. The reservation parameter is explained in conjunction with FIG. 4. The exponential term e^{(Ubi-Ui)} is a monotonically decreasing function of Uᵢ and penalizes the call-type i in proportion to its overloading. The term (Δ−rᵢ) is also monotonically decreasing function of rᵢ and rewards in counter proportion to the priority of the call-type i. Further, the weight corresponding to a call-type that is not overloaded in the predetermined measuring window is assigned zero. As a result, the unused resources are allocated among the call-types that are overloaded in the predetermined measuring window.

At step 315, the unused resources are apportioned among each call-type based on the corresponding weight. The allocation of unused resources for the call-type i is calculated as per the following expression:

$${δ}_{i} = ( \frac{{w}_{i}}{\sum {w}_{i}} Δ ) - {r}_{i} \qquad ( 7 )$$

where, δᵢ is the resource allocation for the call-type i.

In various embodiments of the invention, a throttle value of each call-type is updated based on the reallocated resources corresponding to each call-type. The throttle value corresponding to a call-type is generally used to manage the admission of the calls of the call-type in the communication system in the succeeding predetermined measuring window. In an exemplary embodiment of the invention, the throttle value corresponding to the call type i is given by:

$${Γ}_{i} = \frac{{Ub}_{i} - {U}_{i}}{{Ub}_{i} - {Lb}_{i}} \qquad ( 8 )$$

where,
Γᵢ is throttle value of the call-type i; and
Lbᵢ is the resource-utilization-lower bound of the call-type i.

In an embodiment of the invention, as a consequence of reallocation of resources, the resource-utilization-upper bound corresponding to each call-type is updated and the throttle value is updated based on the updated resource-utilization-upper bound. In an exemplary embodiment of the invention, the updated resources-utilization-upper bound of the call-type i is given by:

$${Ub}_{i}^{new} = {Ub}_{i} + max ( \frac{{w}_{i}}{\sum {w}_{i}} Δ - {r}_{i} , 0 ) \qquad ( 9 )$$

FIG. 4 is a flow diagram of a method for managing a plurality of calls in a communication system, in accordance with another embodiment of the invention. At step 405, predetermined resources are allocated to each call-type in the communication system. In an embodiment of the invention, the predetermined resources corresponding to each call-type is computed based on a Quality of Service (QoS) metric. In the QoS metric approach, a delay QoS metric is specified for each call-type at a normal operating load. Using elementary Queueing theory, the predetermined resources corresponding to each call-type is computed as:

$$U {b}_{i} = \frac{{Λ}_{i} {T}_{i}}{( {Λ}_{i} {T}_{i} - ln ( 0.05 ) )} ; 1 \leq i \leq M \qquad ( 10 )$$

where,
Λᵢ is normal arrival rate of the call-type i;
Tᵢ is QoS delay metric that is specified at 95% delay; and
M is the number of call-types.

In another embodiment of the invention, the plurality of call-types is differentiated based on revenue and priority of a call-type. For example, lower priority can be assigned to call-types that fetch lower revenue per unit call. So, the predetermined resources may be allocated to maximize the revenue subject to the QoS constraints with specified delay.

At step 410, a predetermined reservation parameter is associated to each call-type. The predetermined reservation parameter of a call-type is referred to as a quantity, or threshold, that should be exceeded by the quantity of unused resources before the call-type can borrow the unused resources from other call-types. Therefore, the predetermined reservation parameter of a call-type is intended to prevent the call-type from over borrowing the unused resources. Further, the predetermined reservation parameter of the call-type may be inversely related to the priority of the call-type. In an embodiment of the invention, the predetermined reservation parameter is assigned off-line to a call-type based on an ambient traffic and priority of the call-type.

At step 415, a predetermined measuring window is defined. The calls are regulated at the end of the predetermined measuring window. At step 420, a resource-utilization-upper bound of each call-type in the predetermined measuring window is computed. At step 425, an average resource utilization of each call-type is then measured in the predetermined measuring window. At step 430, CAC is then performed in the communication system. This has been explained in detail in conjunction with FIG. 2 and FIG. 3.

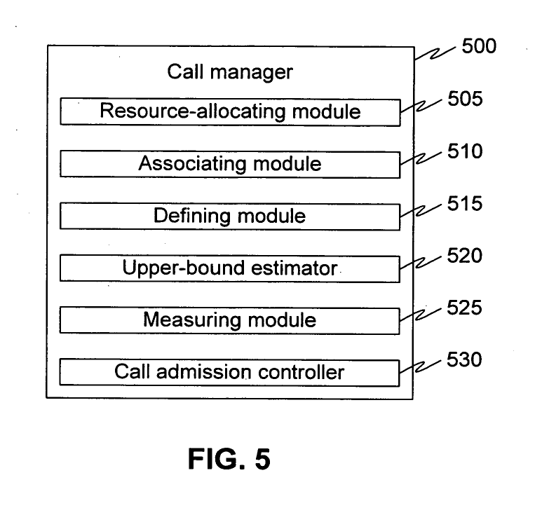

FIG. 5 is a block diagram of a call manager 500 in accordance with an embodiment of the invention. The call manager 500 manages a plurality of calls in a communication system. The communication system comprises at least one call-type and a call belongs to a particular call-type. In an embodiment of the invention, a call-type may be a multimedia call-type. In another embodiment of the invention, a call-type may be a voice call-type. In yet another embodiment of the invention, a call-type may be a data call-type, for example, a short message service (SMS) call-type. In an embodiment of the invention, the call manager 500 may be be implemented on a SoftSwitch.

The call manager 500 comprises a resource-allocating module 505, an associating module 510, a defining module 515, an upper-bound estimator 520, a measuring module 525 and a call admission controller 530 working in conjunction with each other to manager the plurality of calls.

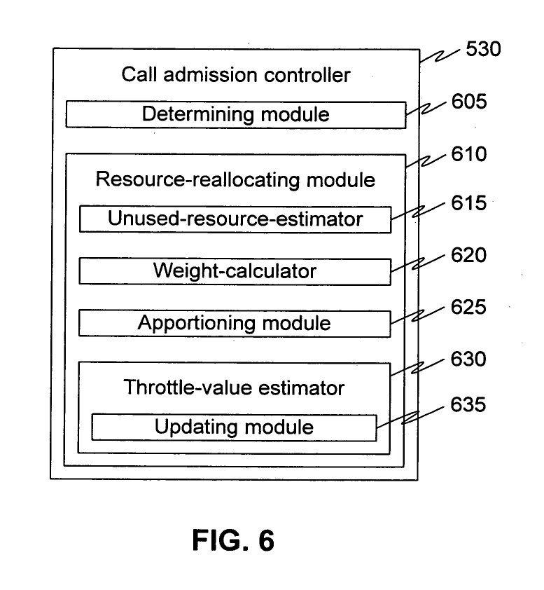

The resource-allocating module 505 allocates resources to a call-type based on an allocation criterion. The allocation criterion to allocate resources to the call-type may be based on a priority of the call-type. The associating module 510 associates a reservation parameter to each call-type. The allocation criterion to allocate resources to the call-type may be further based on the reservation parameter of the call-type. The defining module 515 defines a predetermined measuring window in the communication system to manage the plurality of calls. The upper-bound estimator 520 computes a resource-utilization-upper-bound of each call-type in the predetermined measuring window. The resource-utilization-upper-bound of a call-type may depend on the priority of the call-type. The measuring module 525 then measures an average resource-utilization of each call-type in the predetermined measuring window. The call admission controller 530 performs CAC in the communication system. In an embodiment of the invention, the call admission controller 530 performs CAC at the end of the predetermined measuring window. The call admission controller 530 is explained in conjunction with FIG. 6.

FIG. 6 is a block diagram of the call admission controller 530 in accordance with an embodiment of the invention. The call admission controller 530 comprises a determining module 605 and a resource-reallocation module 610 working in conjunction with each other to perform CAC in the communication system.

The determining module 605 determines whether traffic of at least one call-type is overloaded in the predetermined measuring window. In an embodiment of the invention, traffic of a call-type is overloaded if the average resource utilization corresponding to the call-type is greater than a resource-utilization-upper bound of the call-type. In another embodiment of the invention, traffic of a call-type is overloaded if the average resource utilization corresponding to the call-type is greater than a predetermined threshold.

The resource-reallocating module 610 reallocates resources to each call-type in response to determining whether the traffic of the at least one call-type is overloaded. The resource-reallocating module 610 comprises an unused-resource-estimator 615, a weight-calculator 620, an apportioning module 625 and a throttle-value estimator 630 working in conjunction with each other to reallocate resource among each call-type.

The unused-resource-estimator 615 estimates unused resources available in the communication system in the predetermined measuring window. The weight-calculator 620 calculates weight of each call-type. The weight of a call-type depends on the average resource utilization of the call-type in the predetermined measuring window and the reservation parameter of the call-type. The apportioning module 625 allocates the unused resources available in the communication system in the predetermined measuring window among each call-type. The apportioning of the unused resources among each call-type depends on the corresponding weights of each call-type.

The throttle-value estimator 630 estimates throttle value of each call-type for a succeeding predetermined measuring window. The throttle-value estimator 630 comprises an updating module 635. The updating module 635 updates the resource-utilization-upper-bound of each call-type based on the reallocated resources corresponding to each call-type.

The various embodiments of the invention provide a method and system that manages a plurality of calls belonging to a call-type based on the priority and traffic on the call-type. Further, the various embodiments of invention provide a method and system that differentiates between call-types and penalized overloaded call-types. As a result, the throughput of the traffic improves. Further, QoS is guaranteed and fairness in scheduling for all call-types in ensured.

The various embodiments of the invention further provide a method and system that optimally computes the nominal allocation for each call-type and allocates unused resources in real time in an egalitarian manner.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for performing call admission control (CAC) in a communication system, the method comprising:
determining whether traffic of at least one call-type is overloaded in a predetermined measuring window; and
reallocating the resources of each call-type in response to determining whether traffic of the at least one call-type is overloaded.

2. The method of claim 1, wherein the reallocating step comprises:
estimating unused resources in the predetermined measuring window;
calculating a weight corresponding to each call-type; and
apportioning unused resources among each call-type based on corresponding weight.

3. The method of claim 2, wherein the weight of a call-type is a function of a reservation parameter of the call-type.

4. The method of claim 3, wherein the weight of the call-type is a function of resource utilization of the call-type in the predetermined measuring window and a resource-utilization-upper bound in the predetermined measuring window.

5. The method of claim 2, wherein the weight of a call-type is equal to zero, if the traffic of the call-type is under-loaded in the predetermined measuring window.

6. The method of claim 1, further comprising:
updating a throttle value of each call-type based on the reallocated resources corresponding to each call-type.

7. The method of claim 6, wherein updating step comprises:
updating a resource-utilization-upper bound of each call-type based on the reallocated resources corresponding to each call-type.

8. A method for managing a plurality of calls in a communication system, a call belonging to a call-type, the method comprising:
defining a predetermined measuring window;
measuring an average resource utilization of each call-type in the predetermined measuring window; and
performing call admission control (CAC) in the communication system, wherein the performing step comprises:
determining whether traffic of at least one call-type is overloaded in the predetermined measuring window; and
reallocating the resources of each call-type in response to determining whether traffic of the at least one call-type is overloaded.

9. The method of claim 8, wherein the step of performing CAC is executed at the end of the predetermined measuring window.

10. The method of claim 8, further comprising:
computing a resource-utilization-upper bound of each call-type in the predetermined measuring window.

11. The method of claim 8 further comprising:
allocating predetermined resources to each call-type; and
associating a predetermined reservation parameter to each call-type.

12. The method of claim 11, wherein the predetermined resources are allocated to each call-type based on an unconstrained optimization model.

13. The method of claim 11, wherein the predetermined resources are allocated for each call type based on an optimization model with constraints on QoS delay guarantees.

14. The method of claim 11, wherein a predetermined reservation parameter of a call-type is computed based on the priority of managing the call-type in the communication system.

15. A call manager for managing a plurality of calls in a communication system, a call belonging to a call-type, the call manager comprising:
a defining module, the defining module defining a predetermined measuring window;
a measuring module, the measuring module measuring an average resource utilization of each call-type in the predetermined measuring window; and
a call admission controller, the call admission controller performing call admission control (CAC) in the communication system, wherein the call admission controller comprises:
a determining module, the determining module determining whether traffic of at least one call-type is overloaded in the predetermined measuring window; and
a resource-reallocating module, the resource-reallocating module reallocating the resources of each call-type in response to an input from to the determining module.

16. The call manager of claim 15, wherein the resource-reallocating module comprises:
an unused-resource-estimator, the unused-resource-estimator estimating unused resources in the predetermined measuring window;
a weight-calculator, the weight-calculator calculating a weight corresponding to each call-type; and
an apportioning module, the apportioning module apportioning unused resources among each call-type based on corresponding weight.

17. The call manager of claim 15, wherein the call admission controller further comprises:
a throttle-value-estimator, the throttle-value-estimator estimating a throttle value of each call-type based on the reallocated resources corresponding to each call-type.

18. The call manager of claim 17, wherein the throttle-value-estimator comprises:
an updating module, the updating module updating a resource-utilization-upper bound of each call-type based on the reallocated resources corresponding to each call-type.

19. The call manager of claim 15 further comprising:
an upper-bound estimator, the upper-bound estimator computing a resource-utilization-upper bound of each call-type in the predetermined measuring window.

20. The call manager of claim 15 further comprising:
a resource-allocating module, the resource-allocating module allocating predetermined resources to each call-type; and
an associating module, the associating module associating a predetermined reservation parameter to each call-type.
